(19) United States
(12) Patent Application Publication
(10) Pub. No.: US 2012/0114229 A1
(43) Pub. Date: May 10, 2012

(54) ORTHORECTIFICATION AND MOSAIC OF VIDEO FLOW

(76) Inventor: Guoqing Zhou, Virginia Beach, VA (US)

(21) Appl. No.: 13/011,440

(22) Filed: Jan. 21, 2011

Related U.S. Application Data
(60) Provisional application No. 61/336,353, filed on Jan. 21, 2010.

(51) Int. Cl. G06K 9/34

(52) U.S. Cl. 382/164

(57) ABSTRACT

A method and system are disclosed for creating a real-time, high accuracy mosaic from an aerial video image stream by applying orthorectification of each original video image frame using known ground control points, utilizing a photogrammetric model resolving the object image into pixilation, applying shading to the pixellation, and mosaicking the shaded pixilation of several orthorectified images into a mosaicked image where the mosaicked image is then scaled to the known original image dimensions.

### CROSS REFERENCE TO RELATED APPLICATION

This application claims the benefit of U.S. Provisional Application No. 61/336,353, filed Jan. 21, 2010, which is herein incorporated by reference in its entirety.

### STATEMENT REGARDING GOVERNMENT SUPPORT

The U.S. Government has a paid-up license in this invention and the right in limited circumstances to require the patent owner to license others on reasonable terms as provided for by the terms of Contract NSF 344521 awarded by the U.S. National Science Foundation Contract.

### BACKGROUND OF THE INVENTION

1. Field of the Invention

This pertains to a method of creating a real-time georeferencing and mosaic of digital video flow from aerial perspectives, such as an unmanned aviation vehicle (UAV) transmitted digital video stream, so that the geo-referenced UAV digital image can be merged with other geospatial data for fast-response to time-critical events.

2. Description of the Related Art

A number of conventional approaches to georeferencing and mosaic (also referred to as mosaicking) have been presented over the past decades. The previous approaches have focused on particular operational platforms, such as space or airborne platforms, and images from specific and different sensors, such as radar, visible image devices, and multispectral imaging devices Some of the prior mathematical models ranged from a simple affine transformation, (which utilize higher-order polynomials) to projective transformations. However, there has been a shortage of research for the georeferencing of video from small UAV.

Applications of small, low-cost, moderately functional, varying-in-size, and long-endurance, UAV systems for private sector use, and the use of nonmilitary government agencies to meet geospatial needs—often focusing on small areas of interest—are attracting many researchers. For example, NASA Dryden Research Center, NASA Ames Research Center, and NASA Goddard Space Flight Center have developed different types of UAV systems, which use different onboard types of sensors for a variety of applications, such as homeland security demonstration, forestry fire monitoring, rapid response measurement in emergencies, earth-science research, and the monitoring of gas pipelines. There are many such applications for small and low-cost UAVs, which can include capturing and downlinking real-time videos for homeland security, disaster mitigation, and military operations for time-consuming, labor-intensive, and possibly dangerous tasks, such as bomb detection and search- and research.

An aspect of image data processing in UAV systems is real-time orthorectification and mosaic, so that the georeferenced UAV image can be merged with geospatial data for fast-response to time-critical events. Some previous methods of image orthorectification and mosaic have arisen for different operation platforms. As noted above, these previous methods included mathematical models. In general, these methods can be divided into two types as follows: 1) nonparametric; and 2) parametric. The nonparametric approach is a rigorous solution in which ground control points (GCPs) are generally used. The spatial relationships between an image pixel and its conjugate ground point are characterized by the imaging geometry, which is described by the collinearity condition of the central perspective images. The parametric approach does not need to recover the sensor orientation in advance of the processing. In this method, GCPs are collected at locations where identifiable points are coincident on both the image and a corresponding map. Once enough GCPs are collected, the image coordinates are modeled as functions of the map coordinates using the least squares solution to fit the functions. However, none of these approaches have supplied an effective method, system, or media for the real time mosaic of streaming digital video data from an aerial digital video camera, such as those mounted on UAVs.

### SUMMARY OF THE INVENTION

An aspect of an embodiment includes a mathematical model for real-time orthorectification and mosaic of video flow acquired aerially, such as by a small and low-cost UAV. The developed model is based on photogrammetry bundle model, in which the direct linear transformation (DLT) algorithm is used for calculating the initial values of unknown parameters. This method concentrates the development of a mathematical model for geo-referencing the video stream. The developed model is able to simultaneously solve each of the video camera's interior orientation parameters (IOP) (including lens distortion), and the exterior orientation parameters (EOPs) of video frames.

In one embodiment, the developed model is able to simultaneously solve the video camera's IOPs and the EOPs of each video frame.

In another embodiment, an aspect is that the results demonstrated that the accuracy of the mosaicked video images (i.e., 2-D planimetric map) is approximately 1-2 pixels, i.e., 1-2 m when compared with 55 checked points, which were measured by differential global positioning systems (DGPS) surveying.

In another embodiment, an aspect is that the accuracy of seam lines of two neighbor images is less than 1.2 pixels.

In yet another embodiment, an aspect is that the processing speed and achieved accuracy can meet the requirement of UAV-based real-time response to time-critical events.

In another embodiment, an aspect is that the method is an economical, functional UAV platform that meets the requirements for fast-response to time-critical events.

In another embodiment, the method is adapted to the fact that the boresight matrix in a low-cost UAV system will not be able to remain a constant. This matrix is usually assumed to be a constant over an entire mission in a traditional UAV data processing. Thus, this method takes the exterior orientation parameters of each video frame in a low-cost UAV mapping system and estimates them individually.

In another embodiment the method of real time mosaicking of streaming digital video data from an aerial digital video camera involves providing a digital video camera having GPS and attitude sensors for determining roll, pitch and yaw. The digital video camera is capable of taking at least two digital video image frames. Additionally ground control points are determined in proximate geometric distances from a 3D object. At least two digital video image frames are taken or captured in a known epoch and the digital video camera GPS position, roll, pitch and yaw data is determined. The at least two digital video image frames and the GPS position, roll, pitch and yaw data are stored on a computer readable storage medium. A boresight matrix is estimated from data on a given digital video image frame including the GPS position, roll, pitch and yaw data and ground control points. The boresight matrix is compared to additional digital video image frames with respect to pixel variations of a 3D object image determining the size of the original image. The pixels of a given digital video image frame are then orthorectified on a frame basis using a photogrammetric model into a resulting image. Additionally pixels of the resulting image are assigned a shading or gray scale value and then mosaicking into a composite of the resulting object image. The shading enhances the depiction of the mosaic of any 3D object image of interest.

In yet another embodiment the method for creating a real time mosaic of streaming digital video data from an aerial digital video camera follows the steps of

(i) providing a GPS sensor proximate and in a known relation to the digital video camera;
(ii) providing an attitude sensor proximate to the video camera for determining roll, pitch, and yaw;
(iii) capturing one or more video image;
(iv) comparing a first video image and a second video image;
(v) calibrating the video camera with respect to a plurality of predetermined ground control points;
(vi) extracting feature points from the first video image and second video image;
(vii) comparing and refining the feature point locations;
(viii) estimating a boresight matrix;
(ix) comparing the ground control points, the boresight matrix and refined feature point locations;
(x) calibrating the video camera in relation to the GPS position, roll, pitch, yaw, ground control points and feature point locations;
(xi) inputting the digital elevation model (DEM) as determined by the ground control points and determining the Z axis;
(xii) comparing the DEM and the video camera calibration in step (x);
(xiii) orthorectifying the images using a photogrammetric model;
(xix) assigning shading to determined areas for orthorectification of video images;
(xx) mosaicking the resulting orthorectified video images; and
(xxi) repeating steps (i) to (xx) for all video images.

One embodiment is a method of real time mosaic of streaming digital video data from an aerial digital video camera involving (i) providing a GPS sensor proximate and in known location relative to the video camera for determining position; (ii) providing an attitude sensor proximate and in known location relative to the digital video camera for determining roll, pitch, and yaw; (iii) calibrating the digital video camera with respect to a plurality of predetermined ground control points; (iv) estimating a boresight matrix; and (v) orthorectifying the digital video data photogrammetric model which uses the following equation:

r_{G}^{M}=r_{GPS}^{M}(t)+R_{Att}^{M}(t)·[s_{G}·R_{C}^{Att}·r_{g}^{C}(t)+r_{GPS}^{C}]

wherein r_{G}^{M} is a vector computed for any ground control point G in a given mapping frame; r_{GPS}^{M}(t) is a vector of the GPS sensor in the given mapping frame at a certain epoch (t); s_{G} is a scale factor between at least one given video camera frame and the mapping frame; r_{g}^{C}(t) is a vector observed in a given digital video camera frame image for point g, which is captured and synchronized with the GPS sensor epoch (t); R_{C}^{Att} is the boresight matrix between the digital video camera frame and the attitude sensor; and r_{GPS}^{C} is a vector of position offset between the GPS sensor geometric center and the digital video camera lens center; and R_{Att}^{M}(t) is a rotation matrix from the attitude sensor to the given mapping frame and is a function of the roll, pitch, and yaw.

An alternate embodiment is a system for real time mosaic of streaming digital video data from an aerial position, the system involving: (i) a digital video camera; (ii) a GPS sensor proximate to and in known location relative to the digital video camera for determining position; (iii) an attitude sensor proximate to and in known relationship to the digital video camera for determining roll, pitch, and yaw; (iv) a recording device or computer readable storage device such as a hard drive, optical disk, magnetic tape, flash drive or other known device in communication with the digital video camera, the GPS sensor, and the attitude sensor, for recording digital video data, position data, and roll, pitch, and yaw data; (v) a processing device in communication with the recording device for calibrating the video camera with respect to a plurality of predetermined ground control points, estimating a boresight matrix, and orthorectifying the data using the photogrammetric model equation:

r_{G}^{M}=r_{GPS}^{M}(t)+R_{Att}^{M}(t)·[s_{G}·R_{C}^{Att}·r_{g}^{C}(t)+r_{GPS}^{C}]

wherein r_{G}^{M} is a vector computed for any ground control point G in a given mapping frame; r_{GPS}^{M}(t) is a vector of the GPS sensor in the given mapping frame at a certain epoch (t); s_{G} is a scale factor between a given video camera frame and the mapping frame; r_{g}^{C}(t) is a vector observed in a given image frame for point g, which is captured and synchronized with GPS sensor epoch (t); R_{C}^{Att} is the boresight matrix between the video camera frame and the attitude sensor; and r_{GPS}^{C} is a vector of position offset between the GPS sensor geometric center and the video camera lens center; and R_{Att}^{M}(t) is a rotation matrix from the attitude sensor to the given mapping frame and is a function of the roll, pitch, and yaw.

Another alternate embodiment is a computer readable medium storing a computer program product for real time mosaic of streaming digital video data from an aerial digital video camera; such a computer readable medium might include a hard drive, optical disk, magnetic tape, flash drive or other known device (i) a computer program code for receiving and storing data from the digital video camera; (ii) a computer program code for receiving and storing position data from a GPS receiver proximate to and in known location relative to the digital video camera; (iii) a computer program code for receiving and storing roll, pitch, and yaw from an attitude sensor proximate to and in known relationship to the digital video camera; (iv) a computer program code for calibrating the digital video camera with respect to a plurality of predetermined ground control points; (iv) a computer program code for estimating a boresight matrix; and (v) a computer program code for orthorectifying the digital video data using the photogramxnetric model equation:

r_{G}^{M}=r_{GPS}^{M}(t)+R_{Att}^{M}(t)·[s_{G}·R_{C}^{Att}·r_{g}^{C}(t)+r_{GPS}^{C}]

wherein r_{G}^{M} is a vector computed for any ground control point G in a given mapping frame; r_{GPS}^{M}(t) is a vector of the GPS sensor in the given mapping frame at a certain epoch (t); s_{G} is a scale factor between a given digital video camera frame and the mapping frame; r_{g}^{C}(t) is a vector observed in a given image frame for point g, which is captured and synchronized with GPS sensor epoch (t); R_{C}^{Att} is the boresight matrix between the digital video camera frame and the attitude sensor; and r_{GPS}^{C} is a vector of position offset between the GPS sensor geometric center and the digital video camera lens center; and R_{Att}^{M}(t) is a rotation matrix from the attitude sensor to the given mapping frame and is a function of the roll, pitch, and yaw.

### DESCRIPTION OF THE DRAWINGS

FIG. 1 shows a geometric configuration for UAV-based multisensors, including video camera, GPS, attitude sensor and equation variables.

FIG. 2 is a flowchart of geometric rectification using the block bundle adjustment model.

FIG. 3 shows a photographic aerial view of a Digital Orthophoto Quadrangle (DOQ) and the distribution of the measured 21 nontraditional GCPs.

FIG. 4 is a photograph of the UAV ground control station and field data collection.

FIG. 5 is a photograph of a mosaicked ortho-video and the accuracy estimation of ground coordinates and seam lines of a 2-D planimetric map.

FIG. 6 shows the relationship of the digital video camera and associated system components.

FIG. 7 shows how digital image frames are orthorectified and mosaicked to produce an object image.

### DETAILED DESCRIPTION

The following detailed description is an example of embodiments for carrying out the invention. This description is not to be taken in a limiting sense, but is made merely for the purpose of illustrating general principles of embodiments of the invention.

A method of real-time mosaic may be used with aerial (e.g., UAV) transmitted video stream in order to meet the need of data processing for fast-response to time-critical events. The proposed method is based on a photogrammetry model. Conventional approaches include as follows: Campbell and Wheeler [7] presented a vision-based geolocation method based on a square root sigma point filter technology. However, Dobrokhodov et al. [9] and Campbell and Wheeler [7] exhibited that their methods involved estimate biases that are sensitive to heavy wind conditions. Gibbins et al. [12] reported a geolocation accuracy of over 20 m; Whang et al. [33] described a geolocation solution, in which the range estimates were obtained using a terrain model, and a nonlinear filter was used to estimate the position and velocity of ground moving targets. Barber et al. [2] proposed a method for georectification at localization errors of below 5 m.

### II. Mathematical Model of Orthorectification

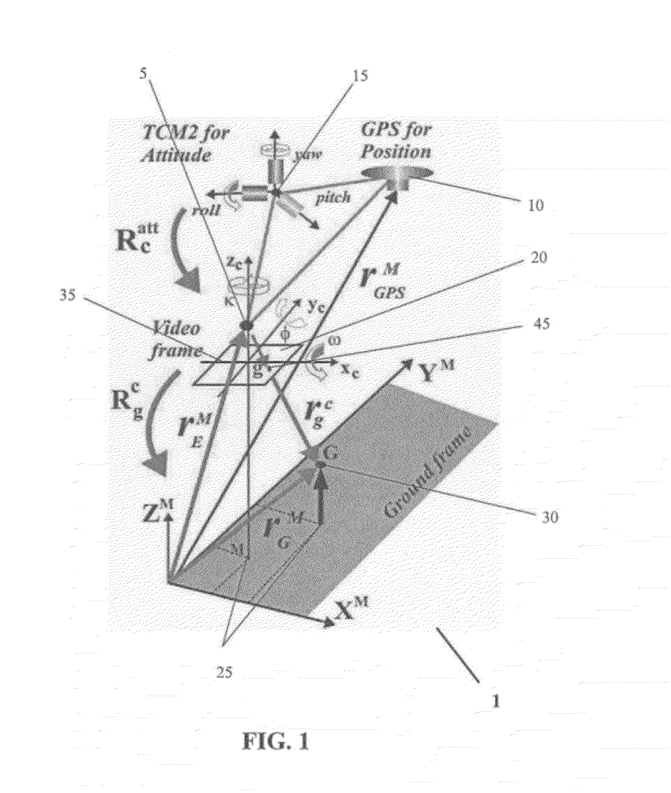

For a UAV system, the geometric configuration between the two navigation sensors and the digital video camera is shown in FIG. 1. The following is an item list to be used in conjunction with FIG. 1
1 System
5 Digital video camera
10 GPS
15 Attitude sensors
20 Image frames
25 Ground control points
30 3D object
35 Boresight matrix
45 3D object image

The mathematical model can be expressed by

r_{G}^{M}=r_{GPS}^{M}(t)+R_{Att}^{M}(t)·[s_{G}·R_{C}^{Att}·r_{g}^{C}(t)+r_{GPS}^{C}] (1)

where r_{G}^{M} is a vector to be computed for any ground point G in the given mapping frame; r_{GPS}^{M}(t) is a vector of the GPS antenna phase center in the given mapping frame, which is determined by the onboard GPS at a certain epoch (t); s_{G} is a scale factor between the camera frame and the mapping frame; r_{g}^{C} (t) is a vector observed in the image frame for point g, which is captured and synchronized with GPS epoch (t); R_{C}^{Att} is the so-called boresight matrix (orientation offset) between the camera frame and the attitude sensor body frame; and r_{GPS}^{C} is the vector of position offset between the GPS antenna geometric center and the camera lens center, which is usually determined by terrestrial measurements as part of the calibration process. R_{Att}^{M}(t) is a rotation matrix from the UAV attitude sensor body frame to the given mapping frame and is a function of the three attitude angles in (2),

$${R}_{Att}^{M} = ( \begin{matrix}cos ψ cos ζ & cos ξ sin k + sin ξ sin ψ cos ζ & sin ξ sin ζ - cos ξ sin ψ cos ζ \\ - cos ψ sin ζ & cos ξ cos k - sin ξ sin ψ sin ζ & sin ξ cos ζ + cos ξ sin ψ sin ζ \\ sin ψ & - sin ξ cos ψ & cos ξ cos ψ\end{matrix} ) \qquad ( 2 )$$

where ξ, Ψ, and ζ represent roll, pitch, and yaw, respectively. Therefore, the relationship between the two sensors is, in fact, to mathematically determinate matrix R_{C}^{Att} through (1). The determination of R_{C}^{Att} is usually solved by a least squares adjustment on the basis of a number of well-distributed GCPs. Once this matrix is determined, its value is assumed to be a constant over the entire flight time in traditional airborne mapping system. The basic procedures of UAV-based orthorectification and mosaic are as follows.

### A. Calibration of Video Camera

The calibration of a video camera may include calibration of parameters such as focal length, principal point coordinates, and lens distortion calibration, which are referred to as interior orientation parameters (IOPs). A direct linear transformation (DLT) method may be used, which was originally presented in [1]. This method requires a set of GCPs whose object space and image coordinates are already known. In this step, the calibration process only considers the focal length and principal point coordinates because the solved IOPs and exterior orientation parameters (EOPs) will be employed as initial values in the later bundle adjustment model. The DLT model is given as:

$$\begin{matrix}\begin{matrix}{x}_{g 1} - {x}_{0} + {ρ}_{1} ( {x}_{g 1} - {x}_{0} ) {r}_{1}^{2} = \frac{{L}_{1} {X}_{G} + {L}_{2} {Y}_{G} + {L}_{3} {Z}_{G} + {L}_{4}}{{L}_{9} {X}_{G} + {L}_{10} {Y}_{G} + {L}_{11} {Z}_{G}} \\ = {\int }_{x}^{1}\end{matrix} & ( 3 a ) \\ \begin{matrix}{y}_{g 1} - {y}_{0} + {ρ}_{1} ( {y}_{g 1} - {y}_{0} ) {r}_{1}^{2} = \frac{{L}_{5} {X}_{G} + {L}_{6} {Y}_{G} + {L}_{7} {Z}_{G} + {L}_{8}}{{L}_{9} {X}_{G} + {L}_{10} {Y}_{G} + {L}_{11} {Z}_{G}} \\ = {\int }_{y}^{1}\end{matrix} & ( 3 b )\end{matrix}$$

where r²₍ᵢ₎=(x_{g(i)}−x₀)²+(y_{g(i)}−y₀)²(i=1, 2); (x_{g1}, y_{g1}) are the coordinates of the image point g₁ in the first image frames; (XG, YG, LG) are the coordinates of the ground point G; (x₀, y₀, f, ρ₁) are the IOPs; and Li(i=1, . . . , 9) are unknown parameters.

Equation (3) is nonlinear equations and may be linearized using Taylor series. The linearized equation is given as:

−[X_{G}L₁+Y_{G}L₂+Z_{G}L₃+L₄+x_{g1}X_{G}L₉+x_{g1}Y_{G}L₁₀+x_{g1}Z_{G}L₁₁]/A+(x_{g1}−x₀)r₁²ρ₁+x_{g1}/A=vₓ (4a)

−[X_{G}L₅+Y_{G}L₆+Z_{G}L₇+L₈+y_{g1}x_{G}L₉+y_{g1}Y_{G}L₁₀+y_{g1}Z_{G}L₁₁]/A+(y_{g1}−y₀)r₁²ρ₁+y_{g1}/A=v_{y} (4b)

The matrix form of (4) is:

V=CΔ+L (5)

where the expressions for C, Δ, V, and L are given in (6), shown at the below. With the iteration computation, the 11 parameters can be solved. With the solved 11 parameters, the IOPs can be calculated by

$$\begin{matrix}C = - \frac{1}{A} ( \begin{matrix}{X}_{G} & {Y}_{G} & {Z}_{G} & 1 & 0 & 0 & 0 & 0 & {x}_{g 1} {X}_{G} & {x}_{g 1} {Y}_{G} & {x}_{g 1} {Z}_{G} & ( {x}_{g 1} - {x}_{0} ) {r}_{1}^{2} \\ 0 & 0 & 0 & 0 & {X}_{G} & {Y}_{G} & {Z}_{G} & 1 & {y}_{g 1} {X}_{G} & {y}_{g 1} {Y}_{G} & {y}_{g 1} {Z}_{G} & ( {y}_{g 1} - {y}_{0} ) {r}_{1}^{2}\end{matrix} ) \\ Δ = {( {L}_{1} {L}_{2} {L}_{3} {L}_{4} {L}_{5} {L}_{6} {L}_{7} {L}_{8} {L}_{9} {L}_{10} {L}_{11} {ρ}_{1} )}^{T} \\ V = ( \begin{matrix}{v}_{x} \\ {v}_{y}\end{matrix} ) \\ L = - \frac{1}{A} ( \begin{matrix}x \\ y\end{matrix} ) & ( 6 ) \\ {x}_{0} = - ( {L}_{1} {L}_{9} + {L}_{2} {L}_{10} + {L}_{3} {L}_{11} ) / ( {L}_{9}^{2} + {L}_{10}^{2} + {L}_{11}^{2} ) & ( 7 ) \\ {y}_{0} = - ( {L}_{5} {L}_{9} + {L}_{6} {L}_{10} + {L}_{7} {L}_{11} ) / ( {L}_{9}^{2} + {L}_{10}^{2} + {L}_{11}^{2} ) & ( 8 ) \\ {\int }_{x}^{2} = - {x}_{0}^{2} + ( {L}_{1}^{2} + {L}_{2}^{2} + {L}_{3}^{2} ) / ( {L}_{9}^{2} + {L}_{10}^{2} + {L}_{11}^{2} ) & ( 9 a ) \\ {\int }_{y}^{2} = - {y}_{0}^{2} + ( {L}_{5}^{2} + {L}_{6}^{2} + {L}_{7}^{2} ) / ( {L}_{9}^{2} + {L}_{10}^{2} + {L}_{11}^{2} ) & ( 9 b ) \\ {\int }_{ }^{ } = \frac{{\int }_{ }^{ } x + {\int }_{ }^{ } y}{2} & ( 10 )\end{matrix}$$

The EOP's can be calculated by:

$${a}_{3} = {L}_{9} / \sqrt{{L}_{9}^{2} + {L}_{10}^{2} + {L}_{11}^{2}}$$

$${b}_{3} = {L}_{10} / \sqrt{{L}_{9}^{2} + {L}_{10}^{2} + {L}_{11}^{2}}$$

$${c}_{3} = {L}_{11} / \sqrt{{L}_{9}^{2} + {L}_{10}^{2} + {L}_{11}^{2}}$$

$${a}_{1} = \frac{1}{{\int }_{ }^{ } x} ( {L}_{1} / \sqrt{{L}_{9}^{2} + {L}_{10}^{2} + {L}_{11}^{2}} + {a}_{3} {x}_{0} )$$

$${b}_{1} = \frac{1}{{\int }_{ }^{ } x} ( {L}_{2} / \sqrt{{L}_{9}^{2} + {L}_{10}^{2} + {L}_{11}^{2}} + {b}_{3} {x}_{0} )$$

$${c}_{1} = \frac{1}{{\int }_{ }^{ } x} ( {L}_{3} / \sqrt{{L}_{9}^{2} + {L}_{10}^{2} + {L}_{11}^{2}} + {c}_{3} {x}_{0} )$$

$${a}_{2} = \frac{1}{{\int }_{ }^{ } y} ( {L}_{5} / \sqrt{{L}_{9}^{2} + {L}_{10}^{2} + {L}_{11}^{2}} + {a}_{3} {y}_{0} )$$

$${b}_{2} = \frac{1}{{\int }_{ }^{ } y} ( {L}_{6} / \sqrt{{L}_{9}^{2} + {L}_{10}^{2} + {L}_{11}^{2}} + {b}_{3} {y}_{0} )$$

$${c}_{2} = \frac{1}{{\int }_{ }^{ } y} ( {L}_{7} / \sqrt{{L}_{9}^{2} + {L}_{10}^{2} + {L}_{11}^{2}} + {c}_{3} {y}_{0} )$$

The rotation matrix can be expressed by:

$${R}_{M}^{C} = ( \begin{matrix}a 1 & a 2 & a 3 \\ b 1 & b 2 & b 3 \\ c 1 & c 2 & c 3\end{matrix} ) \qquad ( 11 )$$

The exposure center coordinates (X_{S}, Y_{S}, Z_{S}) can be calculated by solving the following equations:

a₃X_{S}+b₃Y_{S}+c₃Z_{S}+L′=0 (12a)

x₀+fₓ(a₁X_{S}+b₁Y_{S}+c₁Z_{S})/L′+L₄=0 (12b)

y₀+f_{y}(a₂X_{S}+b₇Y_{S}+c₂Z_{S})/L′+L₈=0 (12c)

where L′=\sqrt{L₉²+L₁₀²+L₁₁²}

### B. Determination of the Offset Between GPS Antenna and Camera

The GPS antenna geometric center and the camera lens center cannot occupy an identical center. The offset (r_{GPS}^{M}) between the two centers is measured so that the correction can be carried out in (1). Precise measurement of the offset may be conducted using a survey imaging station, such as the GTS-2B Total Station available from Topcon®. An embodiment of the process is as follows:
1) Set up the Total Station 5-10 m away from the UAV aircraft;
2) take a shot to the GPS antenna, and read the horizontal and vehicle distance and angles from the imaging station;
3) take a shot to the lens of the camera, during which the vertical wire of telescope of the imaging station is aligned with the telescope axis, and the horizontal wire of telescope of the Total station is aligned with the shut;
4) revise the telescope of the imaging station, and repeat the operations of Steps 2) and 3);
5) repeat the operations of Steps 2), 3), and 4) for three times; and
6) suppose that the origin of a presumed local coordinate is at the imaging station, and calculate coordinates of the GPS antenna (X_{GPS}, Y_{GPS}, Z_{GPS}) and the camera lens (Xₗₑₙₛ, Yₗₑₙₛ, Zₗₑₙₛ); and 7) calculate the offset between the two centers by:

D_{offset}=\sqrt{(X_{GPS}−Xₗₑₙₛ)²+(Y_{GPS}−Yₗₑₙₛ)²+(Z_{GPS}−Zₗₑₙₛ)²}

The measurement accuracy for this embodiment reached on the order of a millimeter level, since survey imaging stations such as the Total Station have a measurement capability of millimeter level.

### C. Solution of Kinematic GPS Errors

For kinematic GPS errors, the baseline length may be limited to ground reference stations for the onboard differential GPS (DGPS) survey. It has been demonstrated that a GPS receiver onboard an UAV can achieve an accuracy of a few centimeters using this limitation [36]. The other errors may be orthorectified mathematically. Basically, the traditional differential rectification model is based on photogrammetric collinearity, in which the interior and exterior orientation elements and DEM (X-, Y-, and Z-coordinates) are known.

### D. Estimation of Boresight Matrix

With the solved EOPs in (11), an initial boresight matrix R_{C}^{Att} can be calculated through multiplication of the attitude sensor orientation data derived from the onboard TCM2™ sensor with the three angular elements of the EOPs solved by DLT. The formula is expressed by

R_{C}^{Att}(t)=[R_{M}^{C}(t)·R_{Att}^{M}(t)]^{T} (13)

where R_{C}^{Att} and R_{Att}^{M} are the same as in (1); R_{M}^{C} is a rotation matrix, which is a function of three rotation angles (ω, φ, and κ) of a video frame, and is expressed as in (14).

$${R}_{M}^{C} = ( \begin{matrix}a 1 & a 2 & a 3 \\ b 1 & b 2 & b 3 \\ c 1 & c 2 & c 3\end{matrix} ) ( \begin{matrix}cos ϕ cos κ & cos ω sin κ + sin ω sin ϕ cos κ & sin ω sin κ - cos ω sin ϕ cos κ \\ - cos ϕ sin κ & cos ω cos κ - sin ω sin ϕ sin κ & sin ωcos κ + cos ωsin ϕ sin κ \\ sin ϕ & - sin ω cos ϕ & cos ω cos ϕ\end{matrix} ) \qquad ( 14 )$$

With the initial values computed earlier, a rigorous mathematical model was established to simultaneously solve the camera's IOPs and EOPs of each video frame. In addition, because stereo camera calibration method can increase the reliability and accuracy of the calibrated parameters due to coplanar constraints [3], a stereo pair of images constructed by the first and the second video frames is selected. The mathematical model for any ground point G can be expressed as follows.

For the first video frame

$$\begin{matrix}{\int }_{x}^{g 1} = - \int \frac{{r}_{11}^{1} ( {X}_{G} - {X}_{S}^{1} ) + {r}_{12}^{1} ( {Y}_{G} - {Y}_{S}^{1} ) + {r}_{13}^{1} ( {Z}_{G} - {Z}_{S}^{1} )}{{r}_{31}^{1} ( {X}_{G} - {X}_{S}^{1} ) + {r}_{32}^{1} ( {Y}_{G} - {Y}_{S}^{1} ) + {r}_{33}^{1} ( {Z}_{G} - {Z}_{S}^{1} )} & ( 15 a ) \\ {\int }_{y}^{g 1} = - \int \frac{{r}_{21}^{1} ( {X}_{G} - {X}_{S}^{1} ) + {r}_{22}^{1} ( {Y}_{G} - {Y}_{S}^{1} ) + {r}_{23}^{1} ( {Z}_{G} - {Z}_{S}^{1} )}{{r}_{31}^{1} ( {X}_{G} - {X}_{S}^{1} ) + {r}_{32}^{1} ( {Y}_{G} - {Y}_{S}^{1} ) + {r}_{33}^{1} ( {Z}_{G} - {Z}_{S}^{1} )} & ( 15 b )\end{matrix}$$

For the second video frame

$$\begin{matrix}{\int }_{x}^{g 2} = - \int \frac{{r}_{11}^{2} ( {X}_{G} - {X}_{S}^{2} ) + {r}_{12}^{2} ( {Y}_{G} - {Y}_{S}^{2} ) + {r}_{13}^{2} ( {Z}_{G} - {Z}_{S}^{2} )}{{r}_{31}^{2} ( {X}_{G} - {X}_{S}^{2} ) + {r}_{32}^{2} ( {Y}_{G} - {Y}_{S}^{2} ) + {r}_{33}^{2} ( {Z}_{G} - {Z}_{S}^{2} )} & ( 16 a ) \\ {\int }_{y}^{g 2} = - \int \frac{{r}_{21}^{2} ( {X}_{G} - {X}_{S}^{2} ) + {r}_{22}^{2} ( {Y}_{G} - {Y}_{S}^{2} ) + {r}_{23}^{2} ( {Z}_{G} - {Z}_{S}^{2} )}{{r}_{31}^{2} ( {X}_{G} - {X}_{S}^{2} ) + {r}_{32}^{2} ( {Y}_{G} - {Y}_{S}^{2} ) + {r}_{33}^{2} ( {Z}_{G} - {Z}_{S}^{2} )} & ( 16 b )\end{matrix}$$

Where r₍ᵢ₎²=(x_{g(i)}−x₀)²+(y_{g(i)}−y₀)²(i=1,2); (x_{g1}, y_{g1}) and (X_{g2}, y_{g2}) are the coordinates of the image points_{g1} and _{g2} in the first and second video frames, respectively; (X_{G}, Y_{G}, Z_{G}) are the coordinates of the ground point G; (x0, y0, f, ρ1) are the IOPs; and r_{i,j}^{m} (i=1, 2, 3; j=1, 2, 3) are elements of the rotation matrix R for the first video frame (when m=1) and the second video frame (when m=2), which are a function of three rotation angles (ω₁, φ₁, κ₁) and (ω₂, φ₂, κ₂). The expression is described in (14). In this model, the unknown parameters contain the camera's IOPs (x₀, y₀, f, ρ₁) and the EOPs of the first and second video frames (X_{S}¹, Y_{S}¹, Z_{S}¹, ω₁, φ₁, κ₁) and (X_{S}², Y_{S}², Z_{S}², ω₂, φ₂, κ₂), respectively. To solve these unknown parameters, (15) and (16) must be linearized by using a Taylor series expansion including only the first-order terms. The vector form of the linearized equation is expressed by:

v₁=A₁X₁+A₂X₂−L

where X₁ represents a vector of the EOPs of two video frames, X₂ denotes the vector of the camera IOPs, A₁ and A₂ are their coefficients, and v₁ is a vector containing the residual error. Their components can be referenced to [36].

### III. Georectification of Video Stream

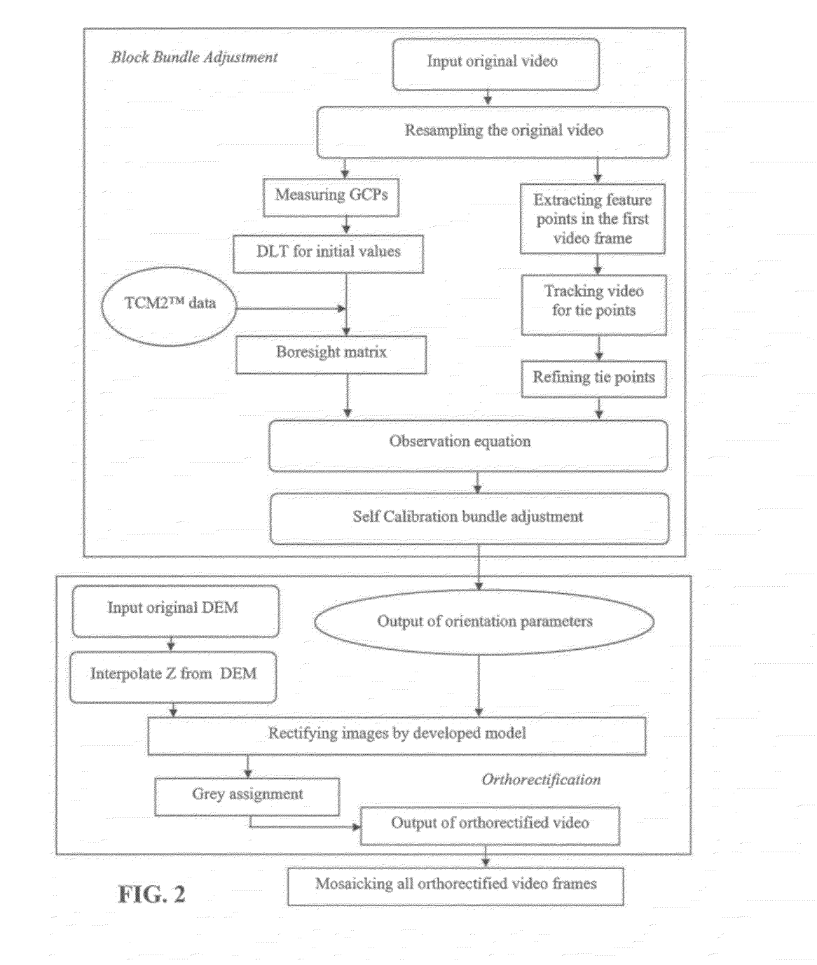

After the orientation parameters of the individual video frame are determined by the model described in Section II, each original video frame may be orthorectified. The procedures include as follows:
1) the determination of the size of the orthorectified image;
2) the transformation of pixel locations from the original image to the resulting (rectified) image using (1); and
3) re-sampling the original image pixels into the rectified image for assignment of gray values.
   The flowchart is shown in FIG. 2.

### A. Determination of Orthorectified Image Size

The orthorectification process registers the original image into a chosen map-based coordinate system, and invariably, the size of the original image is changed. To properly set up the storage space requirements when programming, the size of the resulting image footprint (upper left, lower left, upper right, and lower right) has to be determined in advance. These procedures are as follows.
1) The determination of four corner coordinates: For a given ground resolution of Δ_{Xsample} and Δ_{Ysample} along x- and y-directions in the original image, assume that the planimetric coordinates of any GCP are (X_{GCP}, Y_{GCP}), whose corresponding location in the original image plane is (row_{GCP}, col_{GCP}). The coordinates of four corner points can then be determined routinely. For example, for Corner 1, its coordinates can be calculated by

X₁=X_{GCP}−col_{GCP}·Δ_{Xsample}

Y₁=Y_{GCP}−row_{GCP}·Δ_{Ysample}

The other corners can also be calculated accordingly.

2) The determination of minimum and maximum coordinates from the aforementioned four corners. For example, for the minimum x-coordinate, it can be calculated by

Xₘᵢₙ=min(X₁, X₃).

The maximum x (Xₘₐₓ) and minimum and maximum y (Yₘᵢₙ, Yₘₐₓ) can be calculated accordingly.

3) The determination of size of the resulting image is calculated by

$$N = Col = \frac{{X}_{max} - {X}_{min}}{Δ X}$$

$$M = Row = \frac{{Y}_{max} - {Y}_{min}}{Δ Y}$$

where ΔX and ΔY are the ground-sampled distance (GSD) in the resulting image.

### B. Orthorectification

The basic procedures of orthorectification are as follows:
1) For any point P(I, J) in the resulting image, (I, J) are its image coordinates in the image plane.
2) Compute the planimetric coordinates of the point P(X_{S}, Y_{S}) with respect to the geodetic coordinate system by using the given cell size.
3) Interpolate the vertical coordinates Z_{S} from the given DEM using a bilinear interpolation algorithm.
4) Compute the photo coordinate (x, y) and the image coordinate (i, j) of the point P in the original image by using (1), in which all of the parameters have been determined by the methods described in Section II.
5) Calculate the gray value g_{orig} by a nearest neighbor resampling algorithm.
6) Assign the gray value g_{orig} as the brightness g_{orig} of the resulting (rectified) image pixel.

The aforementioned procedure is then repeated for each pixel to be rectified. The details of the overall process of the orthorectification can be referenced to [37].

### C. Mosaicking

The mathematical model for radiometric balancing and blending operations for scene-to-scene radiometric variations was developed for individual scenes to prevent a patchy or quilted appearance in the final mosaic. In this model, the weights for blending an individual scene along the specified buffer zone are calculated by the following cubic Hermite function:

W=1−3d²+2d³ (18)

G=W·G₁+(1−W)·G₂ (19)

where W is the weighting function applied in the overlap area with values ranging from 0 to 1; d is the distance of a pixel to the buffer line, which is normalized from 0 to 1; G₁ and G₂ are the brightness of overlapping images; and G is the resulting brightness value. In the buffer zone, large intensity values have lower weight, while small brightness values have high weight.

### IV. Experiments and Analysis A. Experimental Field Establishment

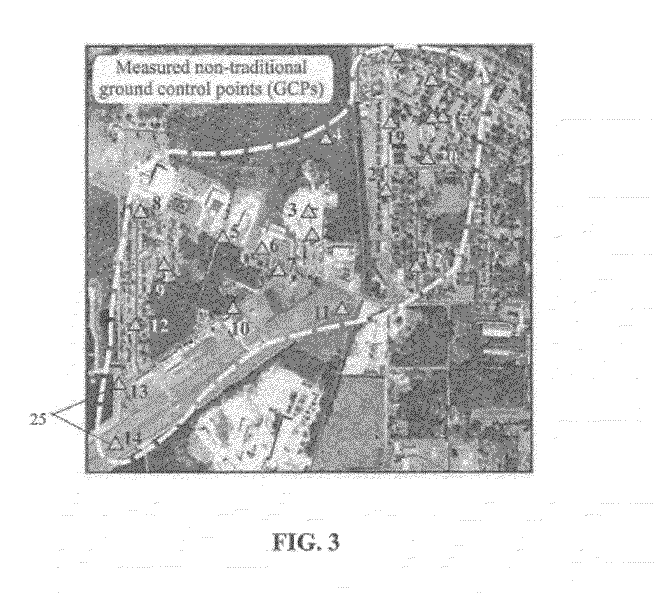

An experimental field, located in Picayune, Miss., approximately 15 min north of the NASA John C. Stennis Space Center, was established. This test field covered about 4 ml long along N.W. and 3.0 ml wide along S.W. In this field, 21 nontraditional GCPs using DGPS were collected. These “GCPs” were located in the corners of sidewalks, parking lots, crossroads, and curb ends (see FIG. 2). Each point was observed for at least 30 min in order to ensure that at least four GPS satellites were locked simultaneously. The height angle cutoff was 15 degrees. The planimetric and vertical accuracy of the “GCPs” was on the order of a decimeter level. This accuracy was enough for the late processing of UAV-based georeferencing and 2-D planimetric mapping because the accuracy evaluation of this system was carried out relative to the USGS DOQ (U.S. Geological Survey, digital orthophoto quadrangle), whose cell size is 1 m. In addition to the 21 nontraditional GCPs, 1-m USGS DOQ imagery (see FIG. 3) covering the control field was also downloaded from the USGS Web site for the accuracy evaluation of UAV-based real-time video data georeferencing and 2-D planimetric mapping.

### B. UAV System

TABLE 1
Specifications of a Low-Cost Civilian UAV Platform

| Power Plant | 2 stroke, 1½ hp | |
|---|---|---|
| Length/Height | 1.53 m × 1.52 m | |
| Gross weight | 10 | kg |
| Operating Altitudes | 152-619 | m |
| Endurance | 45 minutes at cruise speed | |
| Cruise speed | 56 | km/h |
| Max Speed | 89 | km/h |
| Operating Range | 1.6-2.5 | km |
| Fuel Capacity | 0.46 | kg |
| Wingspan | 2.44 | m |
| Payload | 2.3 | kg |

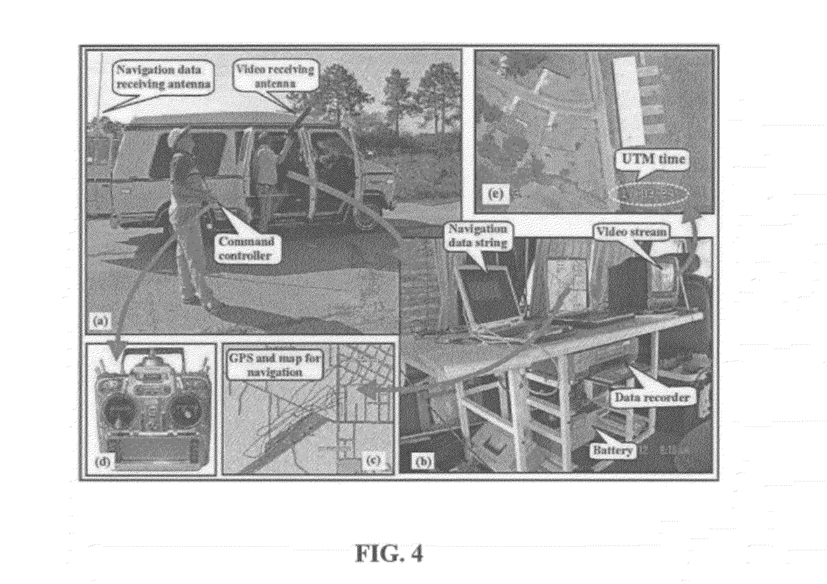

A small UAV system was developed by Zhou et al. [36]. The specifications of the UAV are listed in Table 1. This UAV system was specifically designed as an economical, moderately functional, and small airborne platform intended to meet the requirement for fast-response to time-critical events in private sectors or government agencies for small areas of interest. Cheap materials, such as sturdy plywood, balsa wood, and fiberglass, were employed to craft a proven, versatile and hi-wing design, with tail dragger landing gear for excellent ground clearance that allows operation from semi-improved surfaces. Generous flaps enabled short rolling takeoffs and slow flight. The 1½-hp two-stroke engine operated with a commercial glow fuel mixed with gas (FIG. 4).

In addition, the UAV was constructed to break down into a few easy-to-handle components which quickly pack into a small size van, and was easily deployed, operated, and maintained by a crew of three. This UAV system, including hardware and software, was housed in a lightly converted (rear seat removed and bench top installed) van (FIG. 4), a mobile vehicle that was also used for providing command, control, and data recording to and from the UAV platform, and real-time data processing. The field control station housed the data stream monitoring and UAV position interface computer, radio downlinks, antenna array, and video terminal. All data (GPS data. UAV position and attitude data, and video data) was transmitted to the ground receiver station via wireless communication, with real-time data processing in field for fast-response to rapidly evolving events. In this project, three onboard sensors, GPS, attitude sensor (TCM2™), and video camera were integrated into a compact unit. The GPS Receiver was a handheld model with 12 parallel channels, which continuously tracked and used up to 12 satellites to compute and update the position. The GPS Receiver combined a basemap of North and South America, with a barometric altimeter and electronic compass. The compass provided bearing information, and the altimeter determined the UAV altitude. An attitude navigation sensor was selected to provide the real-time UAV's attitude information. This sensor integrated a three-axis magneto-inductive magnetometer and a high-performance two-axis tilt sensor (inclinometer) in a single package, and provided tilt-compensated compass headings (azimuth, yaw, or bearing angle) and precise tilt angles relative to Earth's gravity (pitch and roll angles) for precise three-axis orientation. The electronic gimbaling eliminated moving parts and provided information about the environment of pitch and roll angles and 3-D magnetic field measurement. Data may be output on a standard RS-232 serial interface with a simple text protocol that includes checksums. A CCD video camera was used to acquire the video stream at a nominal focal length of 8.5 mm with auto and preset manual focus, and program and manual exposure. The camera was installed in the UAV payload bay at a nadir-looking direction. The video stream is recorded with a size of 720 (h)×480 (v) pixel² and delivered in an MPEG-I format.

### C. Data Collection

TABLE 2
RESULTS OF THE THREE METHODS (σ₀ is STANDARD
DEVIATION) FOR THE FIRST VIDEO FRAME

| | | | | X0 | Y0 | f | | σ₀ |
|---|---|---|---|---|---|---|---|---|
| | Roll (ω) | Pitch (Φ) | Yaw (κ) | (pixel) | (pixel) | (pixel) | ρ₁ | (pixel) |
| Onboard | 0.07032 | 0.00245 | 1.08561 | — | — | — | — | |
| TCM2 ™ | | | | | | | | |
| DLT | −0.01039 | 0.00002 | −1.06379 | 362.20 | 241.32 | 790.54 | — | 1.27 |
| Our Method | −0.01873 | 0.00032 | −1.02943 | 361.15 | 239.96 | 804.09 | −1.02e−⁷ | 0.42 |

TABLE 3
ACCURACY STATISTICS OF RESULTS OF THE PROPOSED
METHODS (σ₀ is STANDARD DEVIATION)

| | X_{S} (m) | Y_{S}(m) | Z_{S}(m) | Ω (sec) | Φ(sec) | κ(sec) |
|---|---|---|---|---|---|---|
| Minimum σ₀ | 0.17 | 0.09 | 1.33 | 10.5 | 8.4 | 17.1 |
| Maximum σ₀ | 2.20 | 1.94 | 1.21 | 30.8 | 24.4 | 13.3 |
| Average σ₀ | 1.54 | 1.11 | 1.25 | 21.2 | 17.5 | 15.8 |

The data were collected over the established test field. The UAV and all the other hardware, including computers, monitor, antennas, and the periphery equipment (e.g., cable), and the software developed in this project were housed in the van and transported to the test field via the field control station (see FIG. 4). After the UAV was assembled, all the instruments, such as antenna, computers, video recorder, battery, etc., were set up, and the software system was tested. An autopilot avionics system was employed in this UAV system for command, control, autopilot telemetry, DGPS correction uplink, and the pilot in the loop (manual flight) modes. The autopilot data link was built on a MHz 910/2400 radio modem. The data link has up to 40-kBd throughput and is used. The data architecture allowed multiple aircraft to be controlled by a single operator from a single pound control station. Data from the payload could be downlinked over the main data link. The autopilot included pressure ports for total and static pressure. Both the dynamic and static pressures were used in the autopilot primary control loops.

Video data stream was collected for approximately 60 min and was transmitted (downlinked) to the field control station at real time using a 2.4-GHz S-band transmitter with a 3-dB transmit antenna. The data collection process demonstrated that such received video was acceptably clear [FIG. 4(e)]. Moreover, the UTC time taken from the onboard GPS was overlaid onto the video in the lower right-hand corner [FIG. 4(e)]. Meanwhile, the video was recorded on digital tape. The video was then converted from tape to MPEG-I format.

### D. Bundle Adjustment of Video

With measurement of a number of high-quality nontraditional GCPs described in Section IV-A, all unknown parameters in (1) can be solved. In this model, 11 GCPs were employed, and their imaged coordinates in the first and second images were also measured. The initial values of unknown parameters, including (x₀, y₀, f, ρ₁), (X_{S}¹, Y_{S}¹, Z_{S}¹, ω₁, φ₁, κ₁), and (X_{S}², y_{S}², Z_{S}², ω₂, φ₂, κ₂), were provided by the aforementioned computation. With the initial values, an iterative computation with updating the initial values was carried out, and the finally solved results for the first video frame were listed in Table II.

The aforementioned computational processing can be extended into an entire strip, in which the interesting distinct points must be extracted and tracked. The final tracked distinct points in the video flow could be used as tie points to tie all overlap images together in the bundle adjustment model [i.e., (17)]. From the solution of (17), the EOPs of each video frame can be obtained. A statistical analysis of EOPs for the video flow (correspondingly 18200 video frames) is listed in the last column of Table III. From experimental results, the standard deviation (σ₀) of the six unknown parameters can reach 0.42 pixels. In addition, the maximum, minimum, and average standard deviations of six EOPs are listed in Table III. As shown, the average standard deviations of linear elements of EOPs are less than 1.5 m, and the average standard deviations of nonlinear elements of EOPs are less than 22 s.

### Orthorectijication and Accuracy Analysis

TABLE 4
ACCURACY EVALUATION OF THE 2-D PLANIMETRIC MAPPING
DERIVED USING THREE ORIENTATION PARAMETERS, AND
δX = \sqrt{(X − X′)²/n} AND δY = \sqrt{(Y − Y′)²/n}
WHERE (X, Y) AND (X′, Y′) ARE COORDINATES IN THE 2-D
PLANIMETRIC MAPPING AND THE USGS DOQ, RESPECTIVELY

| Accuracy | | | |
|---|---|---|---|
| relative | From self-calibration | From boresight | From |
| to USGS DOQ | bundle adjustment | alignment | GPS/TCM2 ™ |
| δX(m) | 0.17 | 10.46 | 44.04 |
| δY(m) | 0.25 | 10.33 | 56.26 |

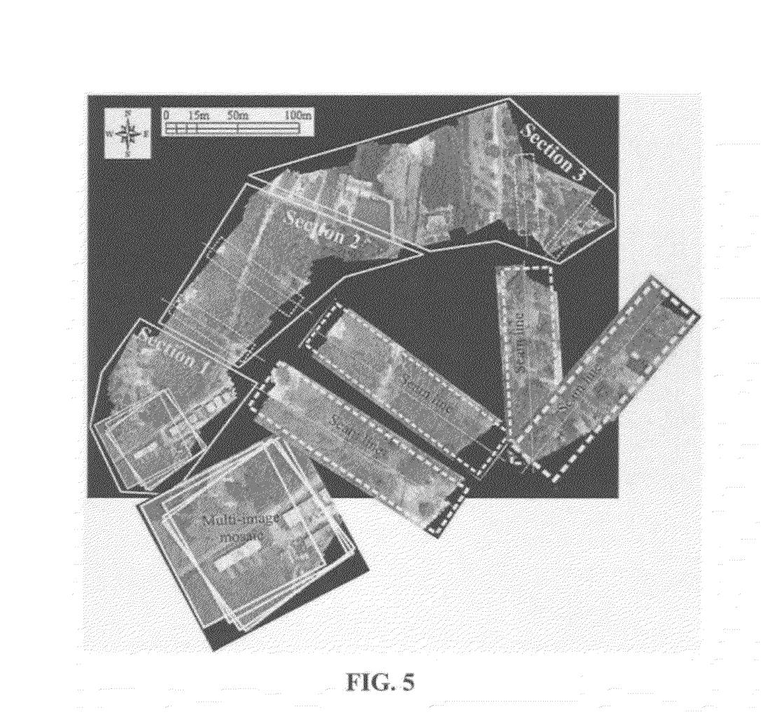

With the previously solved EOPs for each video frame, the generation of georeferencing video can be implemented using the proposed method described in Section III. More details of this method can be referenced to [37]. The method may be used to individually orthorectify each digital video frame and mosaic them together to create a 2-D planimetric mapping covering the test area (FIG. 5). In order to quantitatively evaluate the accuracy (absolute accuracy) achieved by this method, 55 checkpoints were measured in both the mosaicked ortho-video and the USGS DOQ. The results are listed in Table IV. As shown in Table IV, the average accuracy can achieve 1.5-2.0 m (i.e., 1-2 pixels) relative to USGS DOQ. Meanwhile, it was found that the lowest accuracy occurred in the middle area (Section II), due to the paucity and poor distribution of GCPs used in the bundle adjustment model. Sections I and III in FIG. 5 have a relatively higher accuracy due to more GCPs and a better distribution. Therefore, the experimental results demonstrated that the algorithms developed and the proposed method can rapidly and correctly rectify a digital video image within acceptable accuracy limits.

Also measured was the accuracy of seam lines of two overlapping mosaicked images. The sub-windows of the magnified seam lines for the three sections are shown in FIG. 5. The results showed that the accuracy of seam lines in the three sections can achieve less than 1.2 pixels.

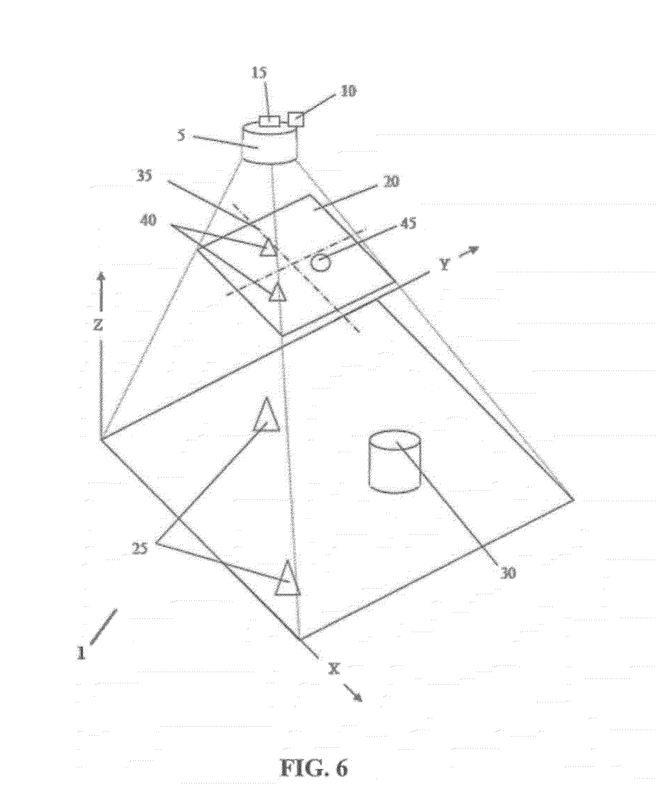

FIG. 6 shows a digital video camera system [1] with a digital video camera [5], GPS [10] and attitude sensors [15] for determining roll, pitch and yaw. The digital video camera [5] is mounted in an unmanned aerial vehicle (UAV) (not shown for clarity). The digital video camera 151 is capable of taking at least two digital video image frames [20]. Ground control points (GCP's) [25] are located in proximate geometric distances from a 3D object [30]. The digital video camera [5] captures at least two digital video image frames [20] in a known epoch and determines the GPS position, roll, pitch and yaw data from the GPS [10] and attitude sensors [15] respectively in relation to any given image frame [20]. Any given image frame [20], along with the GPS position, roll, pitch and yaw data is stored on a computer readable storage medium (not shown) which may be internal or external to the digital video camera [5].

Any given image frame [20] is also the basis for a boresight matrix [35] which is determined from a given image frame [20], GPS position, roll, pitch and yaw data and ground control points [25]. Known parameters from the digital video camera [5] are used to determine pixel data as a measurement between GCP image [40]. GCP [25] data is also compared to the 3D object image [45] to determine location and dimensions of the 3D object [30]. Additional image frames [20] are orthorectified with respect to pixel variations of the 3D object image [45].

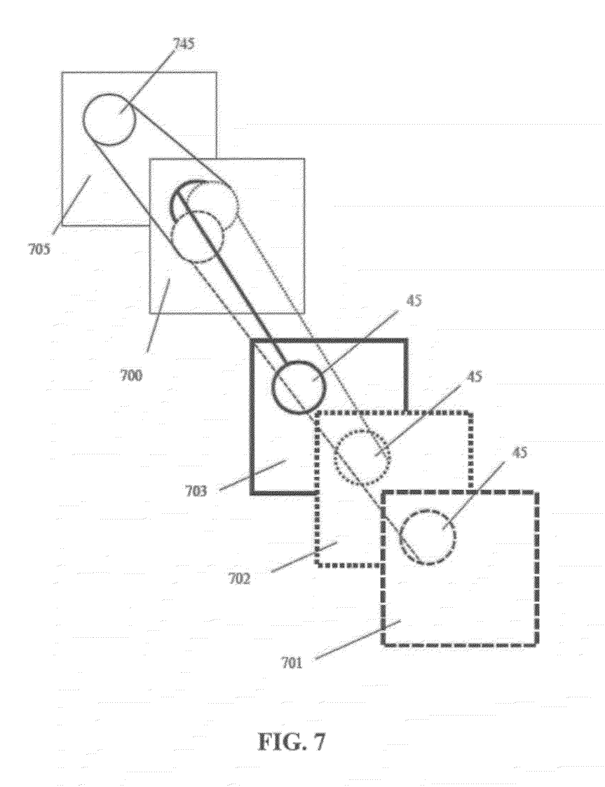

In FIG. 7 shown are a first image frame [701], a second image frame [702] and a third image frame [703] each with a 3D object image [45]. Each image frame [701, 702, 703] has been orthorectified individually. The orthorectified image frames [701, 702, 703] are then manipulated to form a composite orthorectified image [700]. The pixilated 3D object images [45] are then mosaicked to more accurately depict the 3D object [30]. Additional manipulation of the pixels of the mosaicked image [705] with respect to known digital elevation models (DEM) provides gray assignment shading to the mosaicked 3D object image frame [705] and in particular to the 3D object image [745].

This contemplated arrangement may be achieved in a variety of configurations. While there has been described what are believed to be the preferred embodiment(s), those skilled in the art will recognize that other and further changes and modifications may be made thereto without departing from the spirit of the invention, and it is intended to claim all such changes and modifications as fall within the true scope of the invention.

What is claimed is:

1. A method of real time mosaic of streaming digital video data from an aerial digital video camera, comprising:
(i) providing a GPS sensor proximate and in a known location relative to the digital video camera for determining position;
(ii) providing an attitude sensor proximate to and in known relation to the digital video camera for determining roll, pitch, and yaw;
(iii) calibrating the digital video camera with respect to a plurality of predetermined ground control points;
(iv) estimating a boresight matrix;
(v) orthorectifying the digital video data on a frame basis from an original image to a resulting image, wherein each original image comprises a plurality of pixels each having a location within the original image, by determining the size of the original image, transforming pixel locations from the original image to the resulting image by photogrammetric model, and assigning gray values into the resulting image by re-sampling the original image on a pixel basis; and
(vi) mosaicking the resulting images.

2. The method of claim 1, wherein the photogrammetric model uses the following equation:
r_{G}^{M}=r_{GPS}^{M}(t)+R_{Att}^{M}(t)·[s_{G}·R_{C}^{Att}·r_{g}^{C}(t)+r_{GPS}^{C}]
wherein r_{G}^{M} is a vector computed for any ground control point G in a given mapping frame; r_{GPS}^{M}(t) is a vector of the GPS sensor in the given mapping frame at a certain epoch (t); S_{G} is a scale factor between a given digital video camera frame and the mapping frame; r_{g}^{C}(t) is a vector observed in a given image frame for point g, which is captured and synchronized with GPS sensor epoch (t); R_{C}^{Att} is a boresight matrix between the digital video camera frame and the attitude sensor; and r_{GPS}^{C} is a vector of position offset between the GPS sensor geometric center and the digital video camera lens center; and R_{Att}^{M}(t) is a rotation matrix from the attitude sensor to the given mapping frame and is a function of the roll, pitch, and yaw.

3. The method of claim 1, wherein digital video camera is calibrated using a matrix linearization of a direct linear transformation method.

4. The method of claim 1, wherein the digital video camera is calibrated using matrix linearization according to the following equation:
V=CΔ+L
where
$$C = - \frac{1}{A} ( \begin{matrix}{X}_{G} & {Y}_{G} & {Z}_{G} & 1 & 0 & 0 & 0 & 0 & {x}_{g 1} {X}_{G} & {x}_{g 1} {Y}_{G} & {x}_{g 1} {Z}_{G} & ( {x}_{g 1} - {x}_{0} ) {r}_{1}^{2} \\ 0 & 0 & 0 & 0 & {X}_{G} & {Y}_{G} & {Z}_{G} & 1 & {y}_{g 1} {X}_{G} & {y}_{g 1} {Y}_{G} & {y}_{g 1} {Z}_{G} & ( {y}_{g 1} - {y}_{0} ) {r}_{1}^{2}\end{matrix} )$$
$$Δ = {( {L}_{1} {L}_{2} {L}_{3} {L}_{4} {L}_{5} {L}_{6} {L}_{7} {L}_{8} {L}_{9} {L}_{10} {L}_{11} {ρ}_{1} )}^{T}$$
$$V = ( \begin{matrix}{v}_{x} \\ {v}_{y}\end{matrix} )$$
$$L = - \frac{1}{A} ( \begin{matrix}x \\ y\end{matrix} ) .$$

5. The method of claim 1, wherein the boresight matrix is estimated using the following equation:
R_{C}^{Att}(t)=[R_{M}^{C}·R_{Att}^{M}(t)]^{T}
where R_{M}^{C}; is a rotation matrix and a function of three rotation angles (ω, φ, and κ) of a video frame.

6. The method of claim 5, wherein the boresight matrix is estimated using the following equation:
R_{C}^{Att}(t)=[R_{M}^{C}(t)·R_{Att}^{M}(t)]^{T}
where R_{M}^{C} is a rotation matrix and a function of rotation angles ω, φ, and κ of the video frame, and is calculated using the following equation:
$${R}_{M}^{C} = ( \begin{matrix}a 1 & a 2 & a 3 \\ b 1 & b 2 & b 3 \\ c 1 & c 2 & c 3\end{matrix} ) ( \begin{matrix}cos ϕ cos κ & cos ϕ sin κ + sin ω sin ϕ cos κ & sin ω sin κ - cos ω sin ϕ cos κ \\ - cos ϕ sin κ & cos ω cos κ - sin ω sin ϕ sin κ & sin ωcos κ + cos ωsin ϕ sin κ \\ sin ϕ & - sin ω cos ϕ & cos ω cos ϕ\end{matrix} )$$

7. A system for real time mosaic of streaming digital video data from an aerial position, comprising:
(i) a digital video camera for generating digital video data;
(ii) a GPS sensor proximate and in a known location relative to the digital video camera for determining position;
(iii) an attitude sensor proximate to and in known relation to the digital video camera for determining roll, pitch, and yaw;
(iv) a computer readable storage device in communication with the digital video camera, the GPS sensor, and the attitude sensor, for recording digital video data, position data, and roll, pitch, and yaw data;
(v) a processing device in communication with the digital video camera, the GPS sensor, the attitude sensor, and the computer readable storage device for calibrating the digital video camera with respect to a plurality of predetermined ground control points, estimating a boresight matrix, orthorectifying the digital video data on a frame basis from an original image to a resulting image, wherein each original image comprises a plurality of pixels each having a location within the original image, by determining the size of the original image, transforming pixel locations from the original image to the resulting image by photogrammetric model, and assigning gray values into the resulting image by re-sampling the original image on a pixel basis; and for mosaicking the resulting images.

8. The system of claim 7, wherein the real time mosaicking of digital video data uses the following equation:
r_{G}^{M}=r_{GPS}^{M}(t)+R_{Att}^{M}(t)·[s_{G}·R_{C}^{Att}·r_{g}^{C}(t)+r_{GPS}^{C}]
wherein r_{G}^{M} is a vector computed for any ground control point G in a given mapping frame; r_{GPS}^{M}(t) is a vector of the GPS sensor in the given mapping frame at a certain epoch (t); s_{G} is a scale factor between a given digital video camera frame and the mapping frame; r_{g}^{C}(t) is a vector observed in a given image frame for point g, which is captured and synchronized with GPS sensor epoch (t); R_{C}^{Att} is the boresight matrix between the digital video camera frame and the attitude sensor; and r_{GPS}^{C} is a vector of position offset between the GPS sensor geometric center and the digital video camera lens center; and R_{Att}^{M}(t) is a rotation matrix from the attitude sensor to the given mapping frame and is a function of the roll, pitch, and yaw.

9. The system of claim 7, wherein the processing device calibrates the digital video camera using a matrix linearization of a direct linear transformation method.

10. The system of claim 7, wherein the processing device calibrates the digital video camera using matrix linearization according to the following equation:
V=CΔ+L
where
$$C = - \frac{1}{A} ( \begin{matrix}{X}_{G} & {Y}_{G} & {Z}_{G} & 1 & 0 & 0 & 0 & 0 & {x}_{g 1} {X}_{G} & {x}_{g 1} {Y}_{G} & {x}_{g 1} {Z}_{G} & ( {x}_{g 1} - {x}_{0} ) {r}_{1}^{2} \\ 0 & 0 & 0 & 0 & {X}_{G} & {Y}_{G} & {Z}_{G} & 1 & {y}_{g 1} {X}_{G} & {y}_{g 1} {Y}_{G} & {y}_{g 1} {Z}_{G} & ( {y}_{g 1} - {y}_{0} ) {r}_{1}^{2}\end{matrix} )$$
$$Δ = {( {L}_{1} {L}_{2} {L}_{3} {L}_{4} {L}_{5} {L}_{6} {L}_{7} {L}_{8} {L}_{9} {L}_{10} {L}_{11} {ρ}_{1} )}^{T}$$
$$V = ( \begin{matrix}{v}_{x} \\ {v}_{y}\end{matrix} )$$
$$L = - \frac{1}{A} ( \begin{matrix}x \\ y\end{matrix} ) .$$

11. The system of claim 7, wherein the processing device estimates a boresight matrix using the following equation:
R_{C}^{Att}(t)=R_{M}^{C}(t)·R_{Att}^{M}(t)^{T}
where R_{M}^{C} is a rotation matrix and a function of three rotation angles (ω, φ, and κ) of a video frame.

12. The system of claim 11, wherein the processing device estimates a boresight matrix using the following equation:
R_{C}^{Att}(t)=R_{M}^{C}(t)·R_{Att}^{M}(t)^{T}
where R_{M}^{C} is a rotation matrix and a function of rotation angles ω, φ, and κ of the video frame, and is calculated using the following equation:
$${R}_{M}^{C} = ( \begin{matrix}a 1 & a 2 & a 3 \\ b 1 & b 2 & b 3 \\ c 1 & c 2 & c 3\end{matrix} ) ( \begin{matrix}cos ϕ cos κ & cos ω sin κ + sin ω sin ϕ cos κ & sin ω sin κ - cos ω sin ϕ cos κ \\ - cos ϕ sin κ & cos ω cos κ - sin ω sin ϕ sin κ & sin ωcos κ + cos ωsin ϕ sin κ \\ sin ϕ & - sin ω cos ϕ & cos ω cos ϕ\end{matrix} ) .$$

13. A computer readable medium storing a computer program product for real time mosaic of streaming digital video data from an aerial digital video camera, the computer readable medium comprising:
(i) a computer program code for receiving and storing data from the digital video camera;
(ii) a computer program code for receiving and storing position data from a GPS receiver proximate and known location relative to the digital video camera;
(iii) a computer program code for receiving and storing roll, pitch, and yaw from an attitude sensor proximate and known relation to the digital video camera;
(iv) a computer program code for calibrating the digital video camera with respect to a plurality of predetermined ground control points;
(iv) a computer program code for estimating a boresight matrix; and
(v) a computer program for orthorectifying the digital video data on a frame basis from an original image to a resulting image, wherein each original image comprises a plurality of pixels each having a location within the original image, by determining the size of the original image, transforming pixel locations from the original image to the resulting image by photogrammetric model, and assigning gray values into the resulting image by re-sampling the original image on a pixel basis and mosaicking the resulting images.

14. The computer program product of claim 13, wherein the computer program code for orthorectifying the digital video data uses the following equation:
r_{G}^{M}=r_{GPS}^{M}(t)+R_{Att}^{M}(t)·[s_{G}·R_{C}^{Att}·r_{g}^{C}(t)+r_{GPS}^{C}]
wherein r_{G}^{M} is a vector computed for any ground control point G in a given mapping frame; r_{GPS}^{M}(t) is a vector of the GPS sensor in the given mapping frame at a certain epoch (t); s_{G} is a scale factor between a given digital video camera frame and the mapping frame; r_{g}^{C}(t) is a vector observed in a given image frame for point g, which is captured and synchronized with GPS sensor epoch (t); R_{C}^{Att} is the boresight matrix between the digital video camera frame and the attitude sensor; and r_{GPS}^{C} is a vector of position offset between the GPS sensor geometric center and the digital video camera lens center; and R_{Att}^{M}(t) is a rotation matrix from the attitude sensor to the given mapping frame and is a function of the roll, pitch, and yaw.

15. The computer readable medium of claim 13, wherein the digital video camera is calibrated using a matrix linearization of a direct linear transformation method.

16. The computer readable medium of claim 13, wherein the digital video camera is calibrated using matrix linearization according to the following equation:
V=CΔ+L
where
$$C = - \frac{1}{A} ( \begin{matrix}{X}_{G} & {Y}_{G} & {Z}_{G} & 1 & 0 & 0 & 0 & 0 & {x}_{g 1} {X}_{G} & {x}_{g 1} {Y}_{G} & {x}_{g 1} {Z}_{G} & ( {x}_{g 1} - {x}_{0} ) {r}_{1}^{2} \\ 0 & 0 & 0 & 0 & {X}_{G} & {Y}_{G} & {Z}_{G} & 1 & {y}_{g 1} {X}_{G} & {y}_{g 1} {Y}_{G} & {y}_{g 1} {Z}_{G} & ( {y}_{g 1} - {y}_{0} ) {r}_{1}^{2}\end{matrix} )$$
$$Δ = {( {L}_{1} {L}_{2} {L}_{3} {L}_{4} {L}_{5} {L}_{6} {L}_{7} {L}_{8} {L}_{9} {L}_{10} {L}_{11} {ρ}_{1} )}^{T}$$
$$V = ( \begin{matrix}{v}_{x} \\ {v}_{y}\end{matrix} )$$
$$L = - \frac{1}{A} ( \begin{matrix}x \\ y\end{matrix} ) .$$

17. The computer readable medium of claim 13, wherein the boresight matrix is estimated using the following equation:
R_{C}^{Att}(t)=R_{M}^{C}(t)·R_{Att}^{M}(t)^{T}
where R_{M}^{C} is a rotation matrix and a function of three rotation angles (ω, φ, and κ) of a video frame.

18. The computer readable medium of claim 17, wherein the boresight matrix is estimated using the following equation:
R_{C}^{Att}(t)=R_{M}^{C}(t)·R_{Att}^{M}(t)^{T}
where R_{M}^{C} is a rotation matrix and a function of rotation angles ω, φ, and κ of the video frame, and is calculated using the following equation:
$${R}_{M}^{C} = ( \begin{matrix}a 1 & a 2 & a 3 \\ b 1 & b 2 & b 3 \\ c 1 & c 2 & c 3\end{matrix} ) ( \begin{matrix}cos ϕ cos κ & cos ω sin κ + sin ω sin ϕ cos κ & sin ω sin κ - cos ω sin ϕ cos κ \\ - cos ϕ sin κ & cos ω cos κ - sin ω sin ϕ sin κ & sin ωcos κ + cos ωsin ϕ sin κ \\ sin ϕ & - sin ω cos ϕ & cos ω cos ϕ\end{matrix} ) .$$
